(19) United States
(12) Patent Application Publication
(10) Pub. No.: US 2011/0018257 A1
(43) Pub. Date: Jan. 27, 2011

(54) TELESCOPIC PIPE FOR ELECTRONIC APPARATUS

(75) Inventors: Kyong-Hui JEON, Seosan-si (KR); Won-Kyu Lim, Gwangju-city (KR)

Correspondence Address: North Star Intellectual Property Law, PC, P.O. Box 34688, Washington, DC, 20043, US

(73) Assignee: SAMSUNG GWANGJU ELECTRONICS CO., LTD., Gwangju-city (KR)

(21) Appl. No.: 12/775,791

(22) Filed: May 7, 2010

Related U.S. Application Data
(60) Provisional application No. 61/228,211, filed on Jul. 24, 2009.

(30) Foreign Application Priority Data
Oct. 16, 2009 (KR) 10-2009-0098667

(51) Int. Cl. A47L 9/24; F16L 27/12

(52) U.S. Cl. 285/303

(57) ABSTRACT

A telescopic pipe for an electronic apparatus is provided. The telescopic pipe for the electronic apparatus includes an outer pipe, an inner pipe with fixing grooves, inserted into the outer pipe; a holder pipe fixed to one side of the outer pipe, a handle pipe formed to surround the holder pipe, and a sealing member formed on an outer surface of the inner pipe to seal the space between the outer and inner pipes. In the telescopic pipe, the sealing member has at least one sealing portion of which a shape is changed by a negative pressure produced in the interior of the inner pipe so that its sealing force is enhanced.

### CROSS-REFERENCE TO RELATED APPLICATIONS

This application claims benefit under 35 U.S.C. § 119(e) of U.S. Provisional Application No. 61/228,211, filed on Jul. 24, 2009, in the United States Patent and Trademark Office, and under 35 U.S.C. § 119(a) of Korean Patent Application No. 10-2009-0098667, filed on Oct. 16, 2009, in the Korean Intellectual Property Office, the entire disclosures of which are incorporated herein by reference for all purposes.

### BACKGROUND

1. Field

The following description relates to a telescopic pipe, and more particularly, to a telescopic pipe for an electronic apparatus.

2. Description of the Related Art

Telescopic pipes for use with an electronic apparatus are known. Generally, a telescopic pipe for an electronic apparatus has a sealing member to restrict leakage of air between inner and outer pipes. The telescopic pipe may be configured to have a protruding projection formed at one end of the sealing member or to have the shape of an expanded pipe of which outer caliber is expanded.

For example, a sealing member of a telescopic pipe, as shown in EP 0 998 871 B1, has a protruding projection formed at one end thereof, and the external caliber of the protruding projection is larger than the internal caliber of an outer pipe.

The sealing member of a telescopic pipe, as shown in EP 1 872 702 A2, is configured to have a protruding projection formed at one end thereof and to have the shape of an expanded pipe of which external caliber is expanded at the other end thereof.

However, in the aforementioned telescopic pipes, a sealing portion of a sealing member having a protruding projection or an expanded internal caliber comes in strong contact with the internal caliber of an outer pipe. Therefore, when the sealing portion is moved with respect to the outer pipe, there is frictional contact between the sealing portion and the outer pipe. Because of this frictional contact, the sealing portion may become considerably worn from use over time, and air may leak between the inner and outer pipes. Due to the frictional force between the outer pipe and the sealing portion of the sealing member having the outer pipe fixed thereto, much force is applied when the telescopic pipe is operated, and operational ability may be degraded.

Also, since the sealing portion may be formed at a protruding projection or expanded pipe portion, the expanded pipe portion or protruding projection may also be twisted when an end portion of the inner pipe is horizontally shaken and twisted in the interior of the outer pipe. Therefore, a gap between the inner and outer pipes may be formed, and air may be leaked through the gap.

In the configuration of a telescopic pipe for an electronic apparatus, the telescopic pipe shown in EP 1 092 383 A1 has a complex configuration. Furthermore, in the telescopic pipe, two fixing members are formed in a roller shape so that they may be inserted into or separated from a fixing groove formed at an inner pipe. The fixing groove is formed to have a gentle slope.

The telescopic pipe shown in WO 2007/112839 has one fixing member with a roller shape, and both sides of a fixing groove are gently inclined so that the fixing member is inserted into or separated from the fixing groove. However, a plurality of windows, tunnels and the like are formed at the outer circumferential surface of an outer pipe as well as an inner pipe. Therefore, the telescopic pipe has a complex configuration.

The telescopic pipe shown in U.S. Pat. No. 7,025,383 B2 also has a complex configuration, and sides of fixing grooves of an inner pipe are gently inclined so that a fixing member with a lever shape is inserted into or separated from the fixing grooves while coming in contact with the sides of the fixing grooves formed at the inner pipe.

In the aforementioned telescopic pipes, a fixing member may be directly inserted in to a fixing groove of an inner pipe, and is separated from the fixing groove while being in frictional contact with inclined sides of the fixing groove as the inner pipe is pulled and pushed. Therefore, the fixing member is formed in a roller shape so as to be separated from the fixing groove, and both sides of the fixing groove in the length direction of the inner pipe are formed to have a gentle slope.

However, in the aforementioned telescopic pipes, the fixing member with the roller shape may be easily separated from the fixing groove along the gentle slope of the sides of the fixing groove regardless of user's intention, and it may be difficult to firmly fix the inner pipe to the outer pipe. Thus, in use over time, the fixing member may be easily separated from the fixing groove only through an operation of pulling the inner pipe or pushing the inner pipe into the outer pipe. Therefore, it may be difficult to control the telescopic pipes.

### SUMMARY

In one general aspect, there is provided a telescopic pipe for an electronic apparatus, which includes an outer pipe, an inner pipe with fixing grooves, inserted into the outer pipe, a holder pipe fixed to one side of the outer pipe, a handle pipe configured to surround the holder pipe, and a sealing member formed on an outer surface of the inner pipe to seal the space between the outer and inner pipes. The sealing member has at least one sealing portion of which a shape is changed by a negative pressure produced in the interior of the inner pipe so that its sealing force is enhanced.

The sealing member may be formed in a pipe shape and have first and second sealing portions respectively formed at one and the other ends thereof. The first sealing portion may have a wing shape, and the wing shape may be bent in the production of the negative pressure in the interior of the inner pipe. The second sealing portion may have an outer caliber greater than the inner caliber of the outer pipe.

At least one protruding portion may be further formed on the outer surface of the sealing member.

The first and second sealing portions may be formed at both end portions of the sealing member, respectively.

The sealing member may be fixed to surround the outer surface of one end portion of the inner pipe.

The sealing member may have at least two sealing portions, and one of the two sealing portions may have a wing shape and the wing shape is spread in the production of the negative pressure in the interior of the inner pipe so that its sealing force is enhanced.

The sealing member may come into contact with the inner surface of the inner pipe, and the first sealing portion may be positioned in the vicinity of the end portion of the inner pipe.

The telescopic pipe for the electronic pipe may further include an anti-rotation and telescopic control unit having an anti-rotation member for preventing the inner pipe from being rotated with respect to the outer pipe and a fixing member for fixing the telescopic inner pipe. The fixing member may come into contact with the anti-rotation member based on the movement of the anti-rotation member so as to be separated from the fixing grooves.

Accordingly, the telescopic pipe can simultaneously control the anti-rotation and telescopic operation of the inner pipe, and the telescopic pipe can be configured to have a simple structure. Also, the telescopic pipe does not have a configuration in which the fixing member is separated from the fixing grooves due to the side slopes of the fixing grooves of the inner pipe but has a configuration in which the fixing member is separated from the fixing grooves by the anti-rotation member. Therefore, the shape and depth of the fixing grooves can be freely configured, and the inner pipe can be firmly fixed.

The inner pipe may further include a rail groove extended in the length direction of the outer surface thereof, and a plurality of fixing grooves may be formed in the circumferential direction of the outer surface so as to be intersected with the rail groove.

The holder pipe may prevent the anti-rotation member from being separated from the rail groove while surrounding the inner pipe, and have through-holes for holding the fixing member so as to be vertically moved.

The anti-rotation member may be movably mounted in the rail groove, and the fixing member may be inserted into and separated from the fixing grooves while being mounted on or separated from an upper surface of the anti-rotation member.

A groove portion having the fixing member mounted thereon and inclined surface portions respectively formed on both sides of the groove portion may be formed on the upper surface of the anti-rotation member, and the fixing member is vertically moved while coming into contact with the inclined surface portions in the horizontal movement of the anti-rotation member.

The fixing member may include a first contact portion that comes into contact with the anti-rotation member and second contact portions respectively extended to both sides of the first contact portion to be inserted into and separated from the fixing grooves, and the second contact portions may be more protruded than the first contact portion.

A first projection protruded upward may be formed at an upper surface of the fixing member, and a second projection protruded downward may be formed at an inner surface of the handle pipe so as to prevent the vertical movement of the fixing member.

A guide groove may be formed at an outer surface of the holder pipe, and a guide projection inserted into the guide groove may formed at the inner side of the handle pipe so as to guide the handle pipe to be moved in the length direction of the handle pipe.

Other features and aspects will be apparent from the following detailed description, the drawings, and the claims.

### BRIEF DESCRIPTION OF THE DRAWINGS

FIG. 1 is a perspective view of an example of a telescopic pipe for an electronic apparatus.

FIG. 2 is an exploded perspective view of the example of the telescopic pipe shown in FIG. 1.

FIG. 3 is an enlarged perspective view showing examples of a connection state of an anti-rotation member, a holder pipe and an inner pipe in the telescopic pipe shown in FIG. 2.

FIG. 4 is a sectional view of an example of a first portion of a fixing groove, vertically cut away in the state that a fixing member is mounted in the fixing groove in the telescopic pipe shown in FIG. 2.

FIG. 5 is a sectional view taken along line V-V of FIG. 1, illustrating an example of the connection state of a sealing member and the inner pipe.

FIG. 6 is a sectional view of another example of a sealing member.

FIG. 7 is an enlarged perspective view of an example of an anti-rotation member in the telescopic pipe shown in FIG. 2.

FIG. 8 is an enlarged perspective view of an example of the fixing member in the telescopic pipe shown in FIG. 2.

FIG. 9 is a perspective view of an example of an upper handle pipe in the telescopic pipe shown in FIG. 2.

FIG. 10 is a perspective view of an example of a lower handle pipe in the telescopic pipe shown in FIG. 2.

FIG. 11 is a perspective view showing an example of the assembled state of the upper and lower handle pipes respectively shown in FIGS. 9 and 10.

FIG. 12 is a sectional view taken along line XII-XII of FIG. 11.

FIGS. 13A and 13B are views showing an example of the state that a handle pipe is not operated, in which FIG. 13A is a sectional view in the longitudinal direction of the handle pipe, and FIG. 13B is a plan view from which the handle pipe is removed.

FIGS. 14A and 14B are views showing an example of the state where the handle pipe is moved in the direction of arrow A in the telescopic pipe of FIG. 1, in which FIG. 14A is a sectional view in the longitudinal direction of the handle pipe, and FIG. 14B is a plan view from which the handle pipe is removed.

FIGS. 15A and 15B are views showing examples of the state where the handle pipe is moved in the direction of arrow B in the telescopic pipe of FIG. 1, in which FIG. 15A is a sectional view in the longitudinal direction of the handle pipe, and FIG. 15B is a plan view from which the handle pipe is removed.

FIGS. 16 and 17 are sectional views showing an example of the state of first sealed portions and second sealed portions in the state where the sealing members are twisted.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of well-known functions and constructions may be omitted for increased clarity and conciseness.

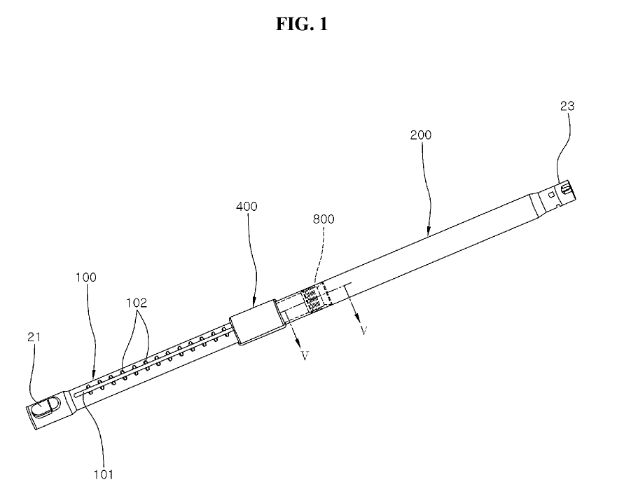

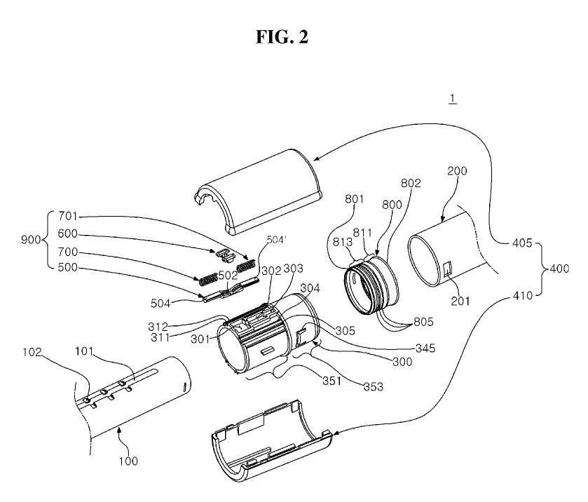

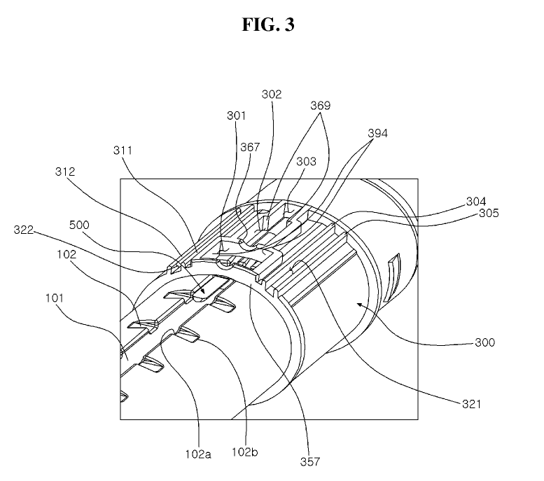

FIG. 1 illustrates a perspective view of an example of a telescopic pipe for an electronic apparatus. FIG. 2 illustrates an exploded perspective view of an example of the telescopic pipe shown in FIG. 1. FIG. 3 illustrates an enlarged perspective view showing examples of a connection state of an anti-rotation member, a holder pipe and an inner pipe in the telescopic pipe shown in FIG. 2.

Referring to FIGS. 1 to 3, for the purposes of example, the telescopic pipe includes an inner pipe 100, an outer pipe 200, a sealing member 800, a holder pipe 300, an anti-rotation and telescopic control unit 900 and a handle pipe 400.

As shown in the examples of FIGS. 1 to 3, the inner pipe 100 may have a circular pipe shape and has a smaller diameter, or caliber, than the outer pipe 200 and the holder pipe 300. The inner pipe 100 may be inserted into the holder pipe 300 and the outer pipe 200. The inner pipe 100 may be made of, for example, a synthetic resin such as plastic, aluminum or a metallic material, but is not limited thereto.

A rail groove 101 or fixing grooves 102 are formed at the outer surface of the inner pipe 100. The rail groove 101 is a groove that may be formed along and continuous in the length direction of the inner pipe 100, and formed deeper than the fixing grooves 102. The fixing grooves 102 may be formed at both sides of the rail groove 101 while being spaced apart from one another at the same interval so that they intersect with the rail groove 101 at a right angle in this example. As shown in FIG. 3, the depth of the fixing grooves 102 is formed shallower than that of the rail groove 101, but the depth is not necessarily limited to this example. Since an anti-rotation member 500 is inserted into the rail groove 101, the depth of the rail groove 101 may be formed deeper than that of the fixing grooves 102 for the purpose of preventing or limiting the rotation of the inner pipe 100 and fixing the inner pipe 100. The rail groove 101 may be continuously formed to have a uniform depth, but the depth of the fixing grooves 102 is not necessarily uniform. That is, as shown in the example of FIG. 3, the depth of a first portion 102a that comes in contact with the rail groove 101 is deepest among the fixing grooves 102, and the depth of a second portion 102b most distant from the rail groove 101 is shallowest among the fixing grooves 102. The depth of the fixing groove 102 is inclinedly formed to be gradually shallower from the first portion 102a to the second portion 102b. Such a configuration may allow the fixing member 600 to be firmly fixed to the fixing grooves 102 and to be easily separated from the fixing grooves 102.

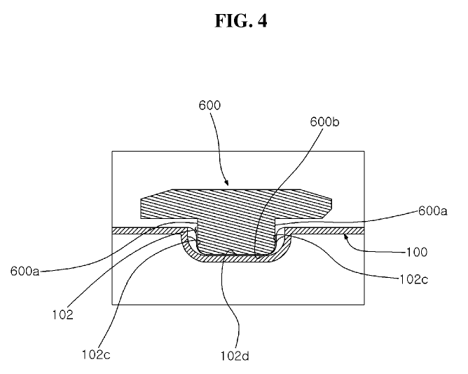

FIG. 4 illustrates a sectional view of an example of the first portion 102a of the fixing groove 102, vertically cut away in the state that the fixing member 600 is mounted in the fixing groove 102. In FIG. 4, it may be seen that a bottom surface 102d and both side surfaces 102c are formed at an almost right angle. The angle made by both side surfaces 600a and a bottom surface 600b of the fixing member 600, come in contact with the fixing groove 102, is also formed at an almost right angle so that the fixing member 600 is inserted into the fixing groove 102 while coming in surface contact with the fixing groove 102. Through the configuration described above, the inner pipe 100 may be more firmly fixed. Although the inner pipe 100 may be pulled out or pushed into the outer pipe 200 in the state that the fixing member 600 is inserted into the fixing groove 102, the fixing member 600 may not be easily separated from the fixing groove 102.

If the handle pipe 400 is pushed or pulled in the length direction thereof, the anti-rotation member 500 pushes up the fixing member 600. Therefore, although the surfaces of the fixing member 600 or the fixing groove 102 are formed at a right angle, the fixing member 600 may easily operate to be separated from the fixing groove 102. The interaction between the fixing grooves 102 and the anti-rotation member 500 is further described later. A locking member 21 for connection of the inner pipe 100 with a vacuum cleaner nozzle (not shown) is formed at one end of the inner pipe 100, and a slot for connection of the inner pipe 100 with the sealing member 800 is formed at the other end of the inner pipe 100 (see FIGS. 1 and 2, for example).

As shown in FIGS. 1 to 3, the outer pipe 200 has a pipe shape. Like the inner pipe 100, the outer pipe 200 may be made of a synthetic resin such as plastic, aluminum or a metallic material, but is not limited thereto. However, no groove is formed at the outer pipe 200, unlike the inner pipe 100. A reduced pipe portion 23 (see FIG. 1) with a reduced internal caliber is formed at one end portion of the outer pipe 200, and an opening 201 (see FIG. 2) for connection of the outer pipe 200 with the holder pipe 300 is formed at the other end portion of the outer pipe 200. The reduced pipe portion 23 may be connected to a vacuum cleaner handle portion (not shown).

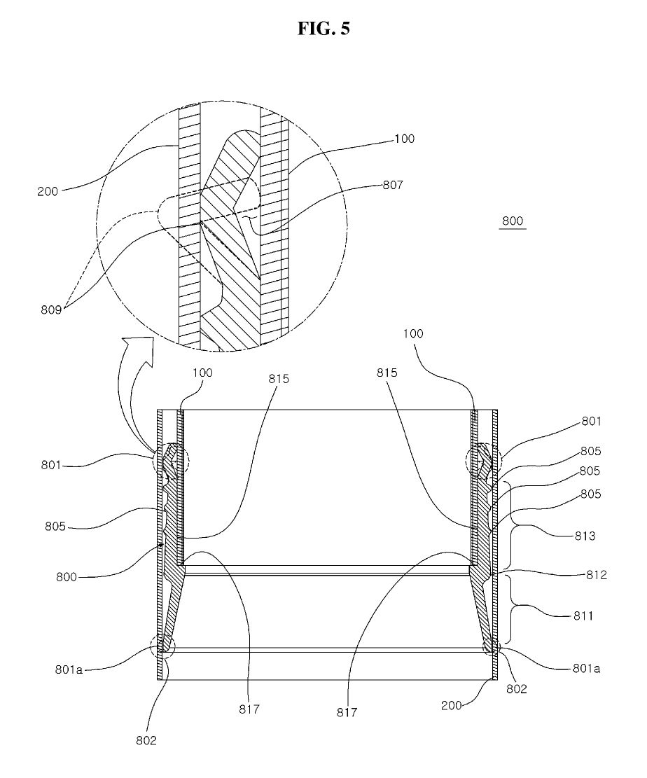

FIG. 5 illustrates a sectional view taken along line V-V of FIG. 1, showing an example of the connection state of the sealing member 800 and the inner pipe 100.

With reference to FIGS. 1, 2, and 5, the sealing member 800 has a pipe shape and includes a first sealing portion 801, a second sealing portion 802, a body portion 813, and an expanded pipe portion 811.

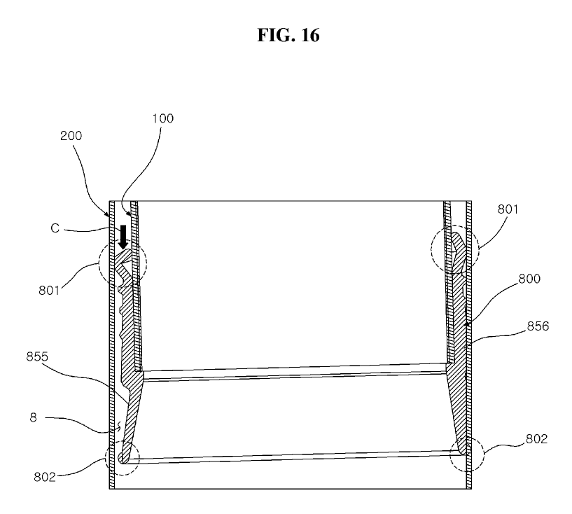

As shown in FIG. 5, the first sealing portion 801 may be formed in a wing shape, or bent shape, at one end portion of the sealing member 800, and an outer surface pressing portion 809 of the bent shape may come in contact with an inner surface of the outer pipe 200. The inner pipe 100 may be horizontally shaken and twisted with respect to the outer pipe 200, which may cause the sealing of the second sealing portion 802 to be broken (see FIG. 16). In this case, the negative pressure in the inner pipe 100 may be conducted up to the first sealing portion 801, and the wing shape is more bent as shown by dotted line of FIG. 5. Hence, a space 807 may be reduced, and the pressing portion 809 may be tightly adhered to the inner surface of the outer pipe 200. Thus, the sealing force of the first sealing portion 801 may be enhanced, and leakage of air may be prevented or limited. That is, through the configuration of the sealing member 800, the sealing force of the first sealing portion 801 may be increased even though the sealing of the second sealing portion 802 is broken, and the air leakage may be effectively prevented or limited. In a case where the sealing of the second sealing portion 802 is not broken, the configuration of the first sealing portion 801 deformed as described above is in the state that the pressing portion 809 is not as strongly adhered to the inner surface of the outer pipe 200 as shown by solid line in the enlarged circle of FIG. 5. Therefore, the frictional force between the outer pipe 200 and the sealing member 800 may be low, and the operational ability of the handle pipe 400 may be high.

As shown in FIG. 5, the second sealing portion 802 may be formed at the other end portion of the sealing member 800, i.e., the end of the expanded pipe portion 811 in the opposite direction of the first sealing portion 801. The expanded pipe portion 811 of the sealing member 800 may be integrally connected with the body portion 813. The expanded pipe portion 811 has a structure in which its internal caliber may be gradually increased from an end of the body portion 813 to the second sealing portion 802. For example, a stepped projection 817 and a projection portion 812 are formed at the end of the body portion 813. Therefore, the external caliber of the second sealing portion 802 is greater than the internal caliber of the outer pipe 200. The second sealing portion 802 has a pressing projection 801a shown by dotted line in FIG. 5. The external caliber of the pressing projection 801a is almost identical to that of the outer pipe 200. As shown in FIG. 5, the pressing projection 801a may be pressed at the inner surface of the outer pipe 200 to seal the space between the outer and inner pipes 200 and 100. Thus, leakage of air between the outer and inner pipes 200 and 100 may be prevented or limited.

Three protruding portions 805 are formed at the outer surface of the body portion 813, and may have a triangle-shaped section. An end portion of each of the protruding portions 805 has a suitable height so as not to come in contact with the inner surface of the outer pipe 200. The protruding portions 805 may function to increase the elasticity of the body portion 813 and to allow the sealing member 800 to strongly surround the outer surface of the inner pipe 100. The number of protruding portions 805 may be varied. The sealing member 800 may be forcibly fitted into the inner pipe 100, and may be made of a material such as rubber with excellent elasticity, for example. If the inner pipe 100 is inserted into the sealing member 800 while being pressed by a forcibly fitting surface 815 that is an inner surface of the sealing member 800, the outer surface of the inner pipe 100 is cut into the forcibly fitting surface 815 by the depth of the stepped projection 817 as shown in FIG. 5. Thus, the inner pipe 100 may be pressed and fixed to the sealing member 800.

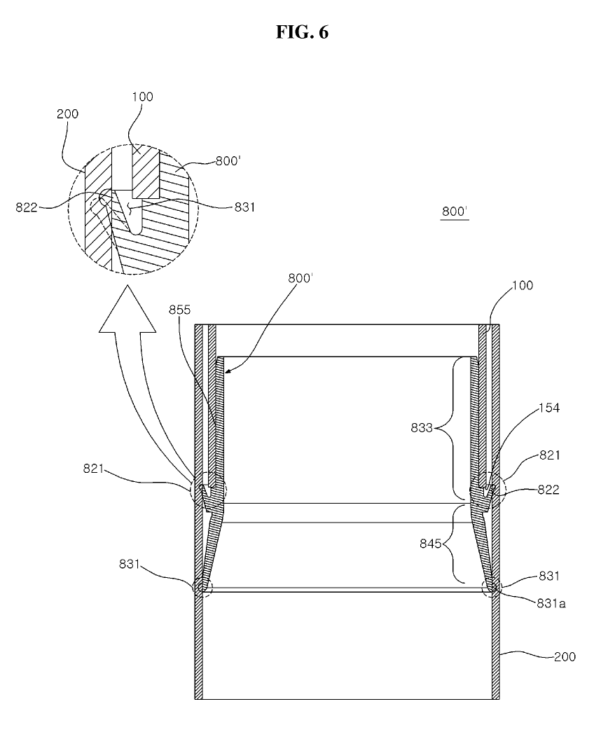

FIG. 6 illustrates a sectional view of another example of a sealing member 800′.

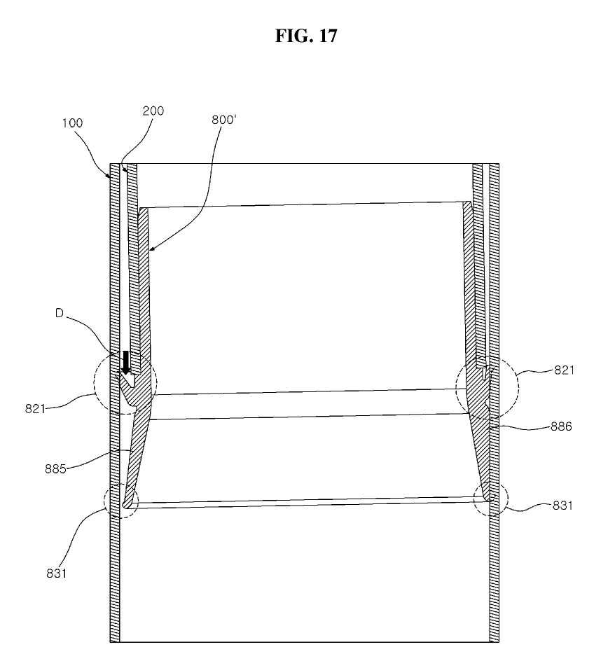

As shown in the example of FIG. 6, the sealing member 800′ has first and second sealing portions 821 and 831. In this example, a first sealing portion 821 is formed between a body portion 833 and an expanded pipe portion 845. When the first sealing portion 821 is connected to the inner pipe 100, the first sealing portion 821 may be positioned in the vicinity of an end portion of the inner pipe 100. When the inner pipe 100 is twisted as described above (see FIG. 17), the sealing effect of the first sealing portion 821 may be more effective than that formed at any other position. For example, if the first sealing portion 821 is formed not to lean toward the end portion of the inner pipe 100 but to lean toward the body portion 833, the area of the body portion 833 joined with a forcibly fitting surface 855 may be decreased, and air may be leaked through an end portion 154 of the inner pipe 100.

According to experiments performed by the applicant, as shown in FIG. 6, for example, the sealing effect of the first sealing portion 821 may be most effective in the structure in which the first sealing portion 821 is positioned at the end portion 154 of the inner pipe 100, i.e., the structure in which the first sealing portion 821 is positioned in the vicinity of the connection between the body portion 833 and the expanded pipe portion 845, even when the sealing of the second sealing portion 831 is broken. As shown in the enlarged part of FIG. 6, when the sealing of the second sealing portion 831 is maintained, a wing 822 of the first sealing portion 821 comes in slight contact with the inner surface of the outer pipe 200 as shown by solid line. However, when the sealing of the second sealing portion 831 is broken (see FIG. 17), e.g., when the sealing member 800′ may be twisted while the inner pipe 100 is horizontally shaken, a space 831a may be widened as shown by the dotted line, and the wing 822 may be more strongly pressed to the inner surface of the outer pipe 200, reinforcing the sealing force of the second sealing portion 831. Thus, it may be possible to ensure the sealing of the second sealing portion 831 while not lowering the operational ability in normal times. The operational relations, in which the first sealing portions 801 and 821 are deformed due to the negative pressure applied by breaking the sealing of the second sealing portions 802 and 831 of the sealing members 800 and 800′, are further described below with reference to FIGS. 16 and 17, respectively.

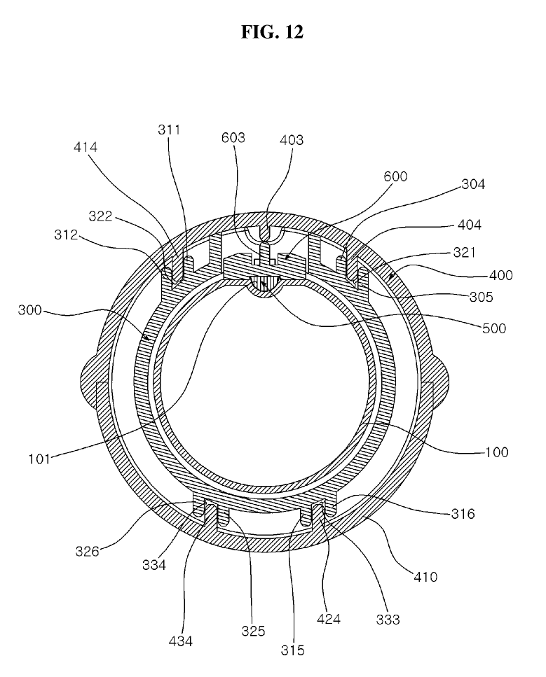

As shown in FIGS. 2 and 3, for example, the holder pipe 300 may have a pipe shape, and is divided into a first portion 351 and a second portion 353. First to third through-holes 301, 302, and 303, first to eighth ribs 304, 305, 311, 312, 315, 316, 325, and 326 and first to fourth guide grooves 321, 322, 333, and 334 (see FIG. 12) are provided at the first portion 351. The fixing member 600 may be inserted into the first through hole 301, and a second spring 701 may be inserted into the second through-hole 302. As shown in FIGS. 3 and 12, pairs of the first to eighth ribs 304, 305, 311, 312, 315, 316, 325, and 326 are protruded to be spaced apart from one another at a predetermined interval, forming the first to fourth guide grooves 321, 322, 333, and 334. First to fourth guide protruding portions 404, 414, 424, and 434 formed at the inner surface of the handle pipe 400 are respectively inserted into the first to fourth guide grooves 321, 322, 333, and 334 so as to guide the handle pipe 400 and the holder pipe 300 to be moved together. As shown in FIG. 2, the second portion 353 of the holder pipe 300 may be a portion connected to one end portion of the outer pipe 200, and may be fixedly inserted into the one end portion of the outer pipe 200. Cut-away portions 345 are formed at both sides of the first portion 351, respectively. The cut-away portions 345 are joined with the openings 201, respectively.

As shown in FIG. 2, the anti-rotation and telescopic control unit 900 includes an anti-rotation member 500, a fixing member 600, first and second springs 700 and 701. As shown in FIG. 3, the anti-rotation member 500 may be movably mounted in the rail groove 101 of the inner pipe 100. Since the holder pipe 300 surrounds the anti-rotation member 500 formed above the anti-rotation member 500, the anti-rotation member 500 is not separated from the rail groove 101.

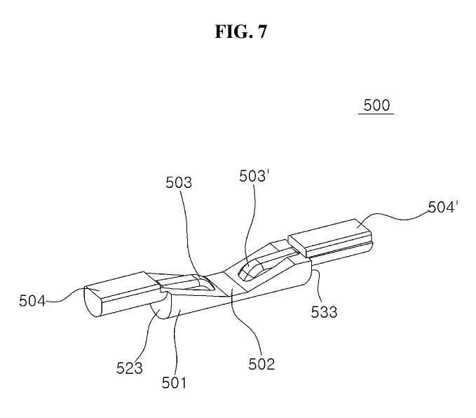

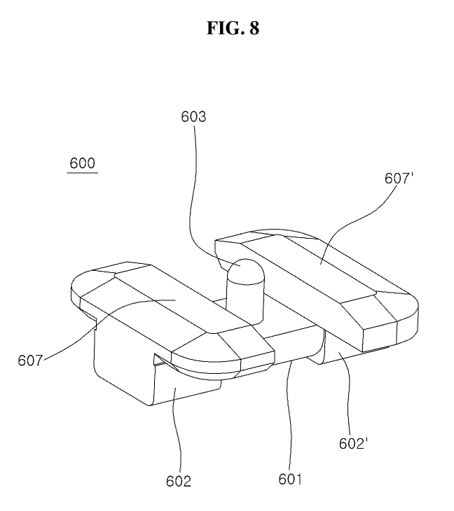

FIG. 7 illustrates an enlarged perspective view of an example of the anti-rotation member 500. FIG. 8 illustrates an enlarged perspective view of an example of the fixing member 600.

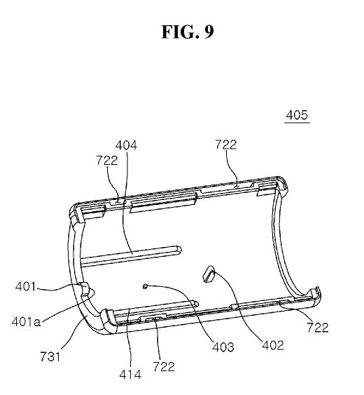

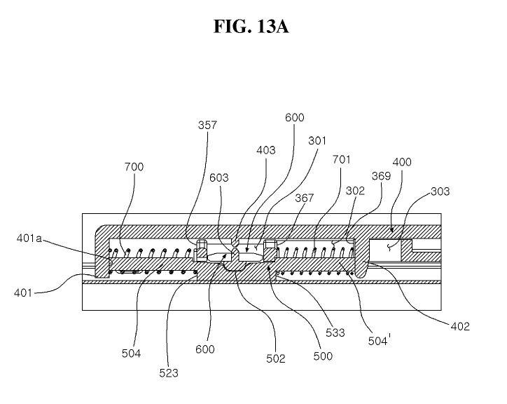

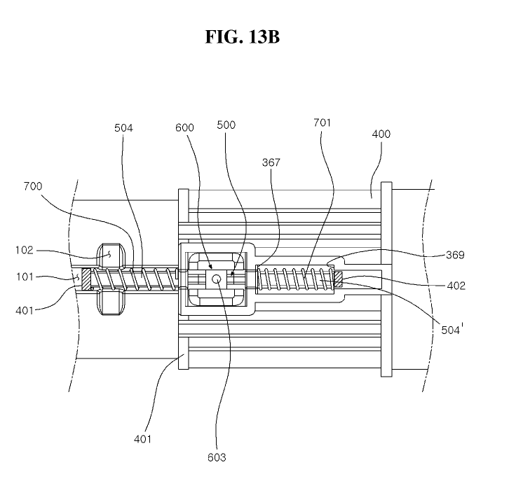

Referring to the example in FIG. 7, the anti-rotation member 500 includes a rail contact portion 501, a groove portion 502, inclined surface portions 503 and 503′, and first and second arms 504 and 504′. The rail contact portion 501 may be a hemisphere-shaped portion inserted into the rail groove 101. The groove portion 502 may be a surface horizontally formed at the central portion of the upper surface of the anti-rotation member 500. Also, the groove portion 502 is a portion on which the fixing member 600 is mounted. The inclined surface portions 503 and 503′ are inclinedly protruded outward from both sides of the groove portion 502, respectively. The protrusion height of the inclined surface portions 503 and 503′ may be designed based on the depth of the fixing grooves 102. When the depth of the fixing grooves 102 is deep, the protrusion height of the inclined surface portions 503 and 503′ may be designed to be high. When the depth of the fixing grooves 102 is shallow, the protrusion height of the inclined surface portions 503 and 503′ may be designed to be low. Through the configuration described above, the fixing member 600 can be easily separated from the fixing grooves 102. The first and second arms 504 and 504′ are portions respectively extended to both sides of the anti-rotation member 500, and may be inserted into the first and second springs 700 and 701, respectively. The movements of both ends of the first and second arms 504 and 504′ may be controlled by the following operation ribs 401 and 402 (see FIG. 9) of the handle pipe 400, respectively (see FIG. 13A).

Referring to FIG. 8, the fixing member 600 includes a first contact portion 601, two second contact portions 602 and 602′, two plate portions 607 and 607′, and a first projection 603. The first contact portion 601 is mounted on the groove portion 502 of the anti-rotation member 500, and the two second contact portions 602 and 602′ are selectively mounted in the fixing grooves 102 of the inner pipe 100. The two second contact portions 602 and 602′ are respectively formed at both sides of the first contact portion 601 so as to be protruded lower than the first contact portion 601. Also the two second contact portions 602 and 602′ may have a quadrangular section identical to that of the fixing grooves 102 (see FIG. 4). The movements of the two plate portions 607 and 607′ are controlled by sidewalls 394 (see FIG. 3) of the first through hole 301 of the holder pipe 300, respectively, so that the fixing member 600 may not be horizontally shaken while being vertically moved. The first projection 603 may be formed in the shape of a column protruded upward between the two plate portions 602 and 602′. The upper portion of the first projection 603 may be formed in a hemispherical shape, and come into contact with the following second projection 403 (see FIG. 9) of the handle pipe 400 so that the fixing member 600 may not be moved upward.

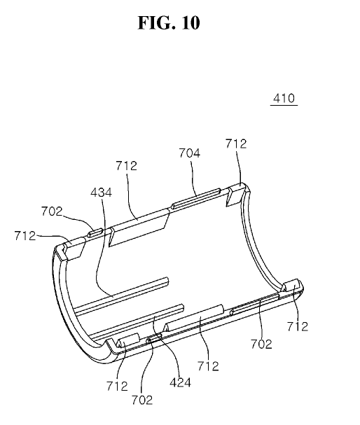

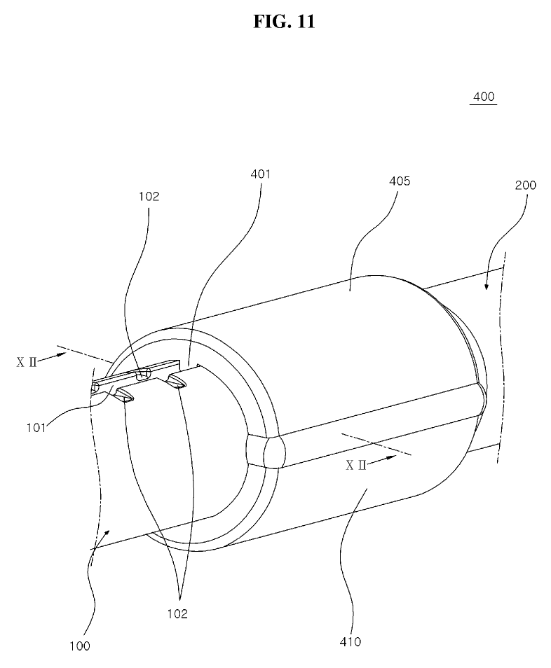

FIG. 9 illustrates a perspective view of an example of the upper handle pipe 405. FIG. 10 illustrates a perspective view of an example of the lower handle pipe 410. FIG. 11 illustrates a perspective view showing an example of the assembled state of the upper and lower handle pipes 405 and 410. FIG. 12 illustrates a sectional view taken along line XII-XII of FIG. 11.

Referring to FIG. 2 and FIGS. 9 to 11, for example, the handle pipe 400 includes the upper handle pipe 405 and the lower handle pipe 410. As shown in the example of FIG. 11, the upper handle pipe 405 and the lower handle pipe 410 may be assembled together so as to surround the anti-rotation and telescopic control unit 900 and the holder pipe 300.

As illustrated in the examples shown in FIGS. 9 and 12, two first and second operation ribs 401 and 402, a second projection 403 and first and second guide protruding portions 404 and 414 are formed on the inner surface of the upper handle pipe 405. The first operation rib 401 may be formed to protrude from a stepped projection 731 formed at one end portion of the upper handle pipe 405, and the end portion of the first operation rib 401 has a rounded shape. When the upper handle pipe 405 is assembled with the lower handle portion 410, one surface 401a of the first operation rib 401 comes in contact with one end of the first spring 700 so that the first spring 700 is selectively pressed (see FIGS. 13A to 15B). The second operation rib 402 may be formed to protrude on the inner surface of the upper handle pipe 405, and the first and second operation ribs 401 and 402 are spaced apart from each other at a predetermined distance with the second projection 403 interposed therebetween. The second operation rib 402 comes in contact with one end of the second spring 701 so that the second spring 701 is selectively pressed (see FIG. 13A). The second projection 403 is protruded from the inner surface of the upper handle pipe 405 at the central portion between the first and second operation ribs 401 and 402. The end of the second projection 403 may be formed in the shape of a rounded cylinder. The first and second guide protruding portions 404 and 414 are formed on the inner surface in the length direction of the upper handle pipe 405, and are extended with the second projection 403 interposed therebetween. A locking guide 702 may be inserted into a locking guide groove 722. The locking guide 702 may be protruded from the lower handle pipe 410.

The lower handle pipe 410 may be assembled with the upper handle pipe 405, to form the handle pipe 400. As shown in FIG. 10, for example, third and fourth guide protruding portions 424 and 434 are formed on the inner surface of the lower handle pipe 410 so as to be protruded and extended in the length direction of the lower handle pipe 410. A plurality of hook members 712 and locking guides 702 are formed at both edge portions of the lower handle pipe 410. The locking guides 702 may be inserted into the locking guide grooves 722 to guide the position at which the upper and lower handle pipes 405 and 410 are assembled together. The hook members 712 are locked with the upper handle pipe 405 to maintain the assembly of the upper and lower handle pipes 405 and 410.

FIG. 11 illustrates a perspective view showing an example of the assembled state of the upper and lower handle pipes 405 and 410. The upper and lower handle pipes 405 and 410 may be assembled to surround the holder pipe 300 and the anti-rotation and telescopic control unit 900. At this time, the first operation rib 401 may be inserted into the rail groove 101. As shown in FIG. 12, the first to fourth guide protruding portions 404, 414, 424, and 434 may be respectively inserted into the first to fourth guide grooves 321, 322, 333, and 334 formed at the holder pipe 300 so as to guide the movement of the handle pipe 400 with respect to the holder pipe 300. The first projection 603 of the fixing member 600 comes into contact with the second projection 403 of the upper handle pipe 405 so that the fixing member 600 may not be moved vertically.

An example the assembly of the telescopic pipe is described with reference to FIG. 2, and its operational relation is described with reference to FIGS. 13A to 15B.

Referring to FIG. 2, in order to assemble the telescopic pipe 1, the inner pipe 100 is inserted into the holder pipe 300, and the sealing member 800 is connected to one end of the inner pipe 100. The second portion 353 of the holder pipe 300 may then be fixed to one end of the outer pipe 200. In the state that the first and second arms 504 and 504′ of the anti-rotation member 500 are respectively inserted into the first and second springs 700 and 701, the anti-rotation member 500 is inserted into the inside of the holder pipe 300 along the rail groove 101 of the inner pipe 100, so that the anti-rotation member 500, the holder pipe 300, and the inner pipe 100 are assembled together as shown in FIG. 3. The fixing member 600 is inserted into the first through-hole 301 so as to be mounted on the groove portion 502 of the anti-rotation member 500, and the upper and lower handle pipes 405 and 410 are assembled together to surround the anti-rotation and telescopic control unit 900 and the holder pipe 300.

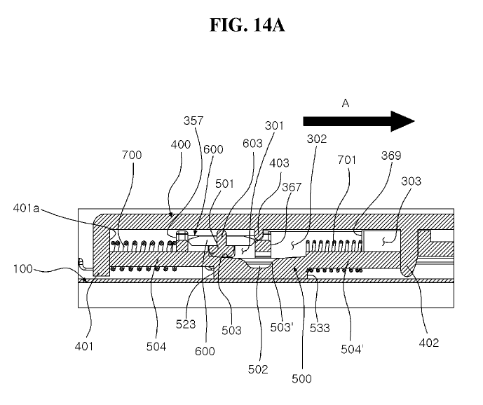

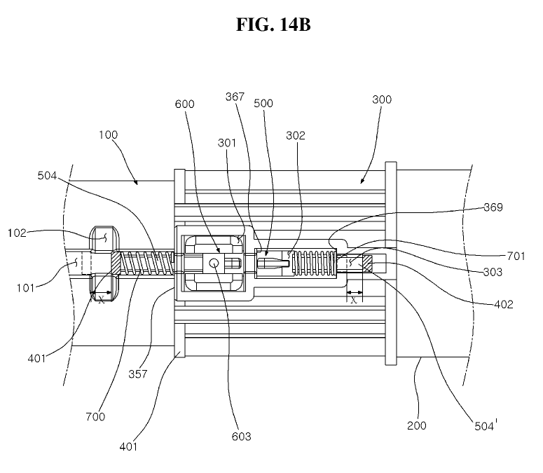

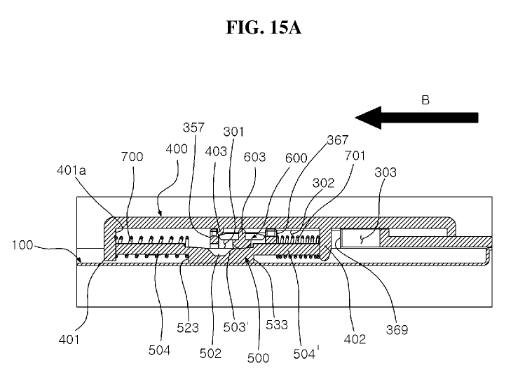

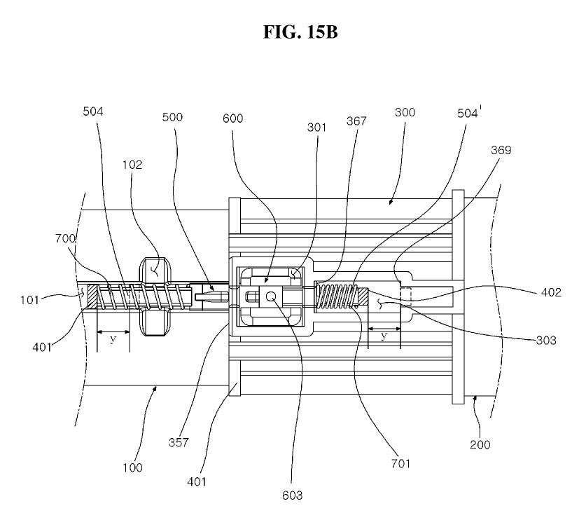

FIGS. 13A and 13B illustrate examples of the state where the handle pipe 400 is not operated. FIGS. 14A and 14B illustrate examples of the state where the handle pipe 400 is moved in the direction of arrow A. FIGS. 15A and 15B illustrate examples of the state where the handle pipe 400 is moved in the direction of arrow B. FIGS. 13A, 14A, and 15A are sectional views in the longitudinal direction of an example of the handle pipe 400. FIGS. 13B, 14B, and 15B are plan views from which the handle pipe 400 is removed.

As shown in FIGS. 13A and 13B, in the state where the handle pipe 400 is not operated, the fixing member 600 is mounted in the groove portion 502 of the anti-rotation member 500, and the first projection 603 comes into contact with the second projection 403. In the state where the first arm 504 is inserted into the first spring 700 of the upper handle pipe 405, one end of the first spring 700 comes into contact with the one surface 401a of the first operation rib 401, and the other end of the first spring 700 are supported while coming into contact with one end portion 357 of the holder pipe 300 and a stepped projection 523 of the anti-rotation member 500. One end of the second spring 701 comes into contact with one surface 367 of the holder pipe 300 and a stepped projection 533 of the anti-rotation member 500, and the other end of the second spring 701 is positioned at a neutral position while coming into contact with the second operation rib 402 of the upper handle pipe 405. As shown in FIG. 4, in such a neutral state, the second contact portions 602 and 602′ of the fixing member 600 are inserted into the fixing grooves 102 so that the movement of the inner pipe 100 is controlled. Therefore, the inner pipe 100 may not be expanded or contracted with respect to the outer pipe 200, and accordingly, the length of the telescopic pipe 1 may not be controlled.

As shown in FIGS. 14A and 14B, if the handle pipe 400 is moved in the direction of arrow A so as to expand or contract the inner pipe 100 with respect to the outer pipe 200, the anti-rotation member 500 that comes into contact with the upper handle pipe 405 is also moved in the direction of the arrow A on the rail groove 101 as the upper handle pipe 405 is moved. That is, as shown in FIGS. 13A and 13B, the anti-rotation member 500 is moved in the direction of the arrow A in the neutral state where the fixing member 600 is fixed in the interior of the first through-hole 301. Hence, the first and second projections 603 and 403 are twisted to each other, and the fixing member 600 mounted on the groove portion 502 of the anti-rotation member 500 is moved upward along the inclined surface portion 503 of the anti-rotation member 500 as shown in FIG. 14A. At this time, the second contact portions 602 and 602′ (see FIG. 8) of the fixing member 600 are separated from the fixing grooves 102, and the inner pipe 100 can be moved in the length direction of the outer pipe 200. Thus, a user may reduce the entire length of the telescopic pipe by expanding the inner pipe 100 as long as desired or by putting the inner pipe 100 into the outer pipe 200. In the state shown in FIGS. 14A and 14B, the gap between the first operation rib 401 and the one end of the holder pipe 300 is narrowed, and therefore, the first spring 700 is pressed. Since the gap between the stepped projection 533 of the anti-rotation member 500 and the stepped projection 369 of the second through-hole 302 is narrowed, the second spring 701 is also pressed. At this time, the second operation rib 402 is separated from the second spring 701 while being moved to the third through-hole 303. In FIG. 14B, distance x denotes a distance at which the handle pipe 400 and the anti-rotation member 500 are moved in the direction of the holder pipe 300.

As shown in FIGS. 15A and 15B, the length of the inner pipe 100 may be controlled with respect to the outer pipe 200 by moving the handle pipe 400 in the opposite direction (the direction of arrow B). If the handle pipe 400 is moved by the distance y, the fixing member 600 is separated from the groove portion 502 of the anti-rotation member 500 and the fixing grooves 102 of the inner pipe 100 while being moved upward along the inclined surface portion 503′ in the opposite direction of FIG. 14A. Thus, the movement of the inner pipe 100 is possible. At this time, the gap between the first operation rib 401 and the stepped projection 523 of the anti-rotation member 500 is maintained constant, and the first spring 700 is not changed (but the gap between the stepped projection 357 of the holder pipe 300 and the first operation rib 401 is widened). Since the distance between the one surface 367 of the second through-hole 302 and the second operation rib 402 is narrowed, the second spring 701 is pressed.

In the state shown in FIGS. 14A and 14B and the state shown in FIGS. 15A and 15B, the user may control the length of the inner pipe 100. That is, the user holds the handle pipe 400 and moves it in the direction of the arrow A of FIG. 14A or the direction of the arrow B of FIG. 15A. Then, the length of the inner pipe 100 is controlled by inserting the inner pipe 100 into the outer pipe 200 or by expanding the inner pipe 100 outward from the outer pipe 200. If the user releases the handle pipe 400, the handle pipe 400 is restored in the neutral state by the elastic force of the pressed first or second spring 700 or 701 as shown in FIGS. 13A and 13B. Thus, the fixing member 600 is inserted into the groove portion 502 of the anti-rotation member 500 and the fixing grooves 102, so that the inner pipe 100 is fixed.

Accordingly, the telescopic pipe may have a simplified structure and be easily assembled. In the telescopic pipe, the inner pipe may be firmly fixed, and the operation of the handle pipe may be easily performed

FIGS. 16 and 17 are sectional views showing the state of first sealed portions 801 and 821 and second sealed portions 802 and 831 in the state the sealing members 800 and 800′ according to the one and another embodiment is twisted.

In the sealing member, when the inner pipe 100 inserted into the outer pipe 200 is twisted in the interior of the outer pipe 200, the sealing member 800 is pressed to one side thereof as shown in FIG. 16. Therefore, one side 855 of the second sealing portion 802 is spaced apart from the outer pipe 200, and the first and second sealing portions 801 and 802 at the other side 856 is pressed to the inner surface of the outer pipe 200. Thus, the sealing force between the outer and inner pipes 200 and 100 may be enhanced at the other side 856, but external air may be absorbed because the negative pressure in inner pipe 100 is provided to a spaced gap 8. However, in the telescopic pipe, the first sealing portion 801 of the sealing member 800 is bent in a wing shape as shown in FIG. 16. Hence, the first sealing portion 801 of the sealing member 800 is more bent by applying a force shown by arrow C to the bent portion, and the inner surface of the outer pipe 200 is more pressed. Accordingly, the sealing force between the inner and outer pipes 100 and 200 may be enhanced.

In FIG. 17, the sealing member 800′ is another example of the sealing member 800. If the second sealing portion 831 at one side 885 is spaced apart from the outer pipe 200 due to the twist of the inner pipe 100 with respect to the outer pipe 200, the other side 886 may be tightly adhered to the outer pipe 200, and the sealing force between the inner and outer pipes 100 and 200 may be enhanced. Also, a negative force is provided to the wing portion of the first sealing portion 821 at the one side 885, and the wing portion is spread by applying a force shown by arrow D to the wing. Thus, the inner surface of the outer pipe 200 is more pressed, and leakage of air may be prevented or limited. The change in the shape of the first sealing portion 821 is been described above, and further description is omitted.

As described above, the telescopic pipe has a sealing portion (a wing-shaped first sealing portion) that may reduce a frictional force in the movement of the inner pipe and is deformed to reinforce a sealing force (sealing effect) in the occurrence of a negative pressure in the inner and outer pipes after the operation of the inner pipe. Accordingly, the telescopic movement of the inner pipe may be easy, and the sealing may be provided. Further, the sealing effect may be continuously maintained in the long-term use.

Also, the leakage of air may be effectively prevented or limited by the sealing portion (the wing-shaped first sealing portion) deformed by the negative pressure provided even when a gap is produced at an end portion of sealing portion because one end portion of the inner pipe is twisted while being horizontally shaken in the interior of the outer pipe. Accordingly, the sealing may be provided. Particularly, when the wing portion is positioned at the end portion of the inner pipe, the sealing effect may be enhanced.

Also, through the configuration of an anti-rotation and telescopic control unit, in which it is unnecessary to perform processing for the outer pipe and the anti-rotation and telescopic operation of the inner pipe are simultaneously controlled, the entire configuration of the telescopic pipe may be simplified, and the manufacturing and assembling of the telescopic pipe may be conveniently performed. Further, the number of assembling processes may be reduced.

Through the configuration of the telescopic pipe for the electronic apparatus, in the operation of the telescopic pipe before its shape is changed, the frictional force between the sealing portion and the outer pipe is low, and the telescopic pipe may be easily operated. When the shape of the sealing portion is changed due to the negative pressure produced in the operation of the telescopic pipe after the telescopic pipe is operated, the sealing portion strongly presses the outer pipe, enhancing the sealing force, as noted above.

Also, the telescopic pipe may not have a configuration in which the fixing member is separated from the fixing grooves due to the side slopes of the fixing grooves of the inner pipe but has a configuration in which the fixing member may be separated from the fixing grooves by the anti-rotation member. Therefore, the shape and depth of the fixing grooves may be freely configured. Accordingly, the inner pipe may be firmly fixed, and the convenient operation of the inner pipe may be provided.

The telescopic pipe has a configuration in which the anti-rotation member and the fixing member are moved while coming into contact with each other. Therefore, although the depth of the fixing grooves is deep, the fixing member can be easily separated from the fixing grooves. Hence, the operational ability of the telescopic pipe is not degraded.

After the holder pipe is assembled once, the anti-rotation member may not be absolutely separated from the rail groove. Therefore, it is possible to prevent the inner pipe from being rotated with respect to the outer pipe. Also, the fixing member in the through-hole may be vertically moved, but may not be horizontally slid or separated.

A number of examples have been described above. Nevertheless, it will be understood that various modifications may be made. For example, suitable results may be achieved if the described techniques are performed in a different order and/or if components in a described system, architecture, device, apparatus or circuit are combined in a different manner and/or replaced or supplemented by other components or their equivalents. Accordingly, other implementations are within the scope of the following claims.

What is claimed is:

1. A telescopic pipe for an electronic apparatus, the telescopic pipe comprising:
an outer pipe;
an inner pipe comprising fixing grooves, inserted into the outer pipe;
a holder pipe fixed to one side of the outer pipe;
a handle pipe configured to surround the holder pipe; and
a sealing member formed on an outer surface of the inner pipe, and configured to seal the space between the outer and inner pipes,
wherein the sealing member comprises at least one sealing portion of which a shape is configured to be changed by a negative pressure produced in the interior of the inner pipe so that its sealing force is enhanced.

2. The telescopic pipe of claim 1, wherein:
the sealing member is formed in a pipe shape, and comprises first and second sealing portions respectively formed at one and the other ends thereof;
the first sealing portion comprises a wing shape, the wing shape being bent in the production of the negative pressure in the interior of the inner pipe; and
the second sealing portion comprises an outer caliber greater than the inner caliber of the outer pipe.

3. The telescopic pipe of claim 2, wherein at least one protruding portion is further formed on the outer surface of the sealing member.

4. The telescopic pipe of claim 2, wherein the first and second sealing portions are formed at both end portions of the sealing member, respectively.

5. The telescopic pipe of claim 4, wherein the sealing member is fixed to surround the outer surface of one end portion of the inner pipe.

6. The telescopic pipe of claim 1, wherein:
the sealing member comprises at least two sealing portions; and
one of the two sealing portions has a wing shape and the wing shape is spread in the production of the negative pressure in the interior of the inner pipe so that its sealing force is enhanced.

7. The telescopic pipe of claim 6, wherein:
the sealing member is further configured to come in contact with the inner surface of the inner pipe; and
the first sealing portion is positioned in the vicinity of the end portion of the inner pipe.

8. The telescopic pipe of claim 1, further comprising an anti-rotation and telescopic control unit comprising:
an anti-rotation member configured to prevent the inner pipe from being rotated with respect to the outer pipe; and
a fixing member configured to fix the telescopic inner pipe,
wherein the fixing member is further configured to come in contact with the anti-rotation member based on the movement of the anti-rotation member so as to be separated from the fixing grooves.

9. The telescopic pipe of claim 8, wherein:
the inner pipe further comprises a rail groove extended in the length direction of the outer surface thereof; and
a plurality of fixing grooves are formed in the circumferential direction of the outer surface so as to be intersected with the rail groove.

10. The telescopic pipe of claim 9, wherein:
the holder pipe is configured to prevent the anti-rotation member from being separated from the rail groove while surrounding the inner pipe; and
the holder pipe comprises through-holes for holding the fixing member so as to be vertically moved.

11. The telescopic pipe of claim 9, wherein:
the anti-rotation member is movably mounted in the rail groove; and
the fixing member is inserted into and separated from the fixing grooves while being mounted on or separated from an upper surface of the anti-rotation member.

12. The telescopic pipe of claim 11, wherein:
a groove portion comprising the fixing member mounted thereon and inclined surface portions respectively formed both sides of the groove portion are formed on the upper surface of the anti-rotation member; and
the fixing member is vertically moved while coming into contact with the inclined surface portions in the horizontal movement of the anti-rotation member.

13. The telescopic pipe of claim 12, wherein:
the fixing member comprises a first contact portion configured to come in contact with the anti-rotation member and second contact portions respectively extended to both sides of the first contact portion to be inserted into and separated from the fixing grooves; and
the second contact portions are more protruded than the first contact portion.

14. The telescopic pipe of claim 8, wherein:
a first projection protruded upward is formed at an upper surface of the fixing member; and
a second projection protruded downward is formed at an inner surface of the handle pipe so as to prevent the vertical movement of the fixing member.

15. The telescopic pipe of claim 8, wherein:
a guide groove is formed at an outer surface of the holder pipe; and
a guide projection inserted into the guide groove is formed at the inner surface of the handle pipe so as to guide the handle pipe to be moved in the length direction of the handle pipe.
